(19) United States
(12) Patent Application Publication
(10) Pub. No.: US 2014/0187164 A1
(43) Pub. Date: Jul. 3, 2014

(54) ELECTRONIC DEVICE AND METHOD FOR CREATING WIRELESS COMMUNICATION CONNECTION THEREFOR

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: MIN YANG, Wuhan (CN); JIAN-HUNG HUNG, New Taipei (TW); XIN-SHU WANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/141,460

(22) Filed: Dec. 27, 2013

(30) Foreign Application Priority Data
Dec. 27, 2012 (CN) 2012105778231

(51) Int. Cl. H04W 76/02; G06K 9/00; H04W 4/00

(52) U.S. Cl. CPC H04W 76/023; H04W 4/008; G06K 9/00536
USPC 455/41.2

(57) ABSTRACT

An electronic device for creating a wireless communication connection includes a wireless communication unit, a processing unit, a camera unit, and a memory. The camera unit captures a picture of a neighboring wireless communication-enabled device. The memory stores a number of pictures of wireless communication-enabled device which can be communicated with the electronic device via wireless communication. When the processing unit determines the captured picture matches a picture pre-stored in the memory, the wireless communication unit creates a communication connecting between the electronic device and the neighboring wireless communication-enabled device. A method applied in the electronic device is also provided.

### BACKGROUND

1. Technical Field

The present disclosure relates to an electronic device and a method for creating a wireless communication connection for the electronic device.

2. Description of Related Art

Electronic devices equipped with Bluetooth modules are popular (Bluetooth is a registered certification mark). Such an electronic device can be used to establish a wireless communication connection with a Bluetooth-enabled device (hereinafter, “Bluetooth device”) such as a Bluetooth-enabled earphone, a Bluetooth-enabled speaker, or a mobile terminal with a Bluetooth communication function. When the electronic device is used to establish such a wireless connection, the electronic device wirelessly searches neighboring Bluetooth devices, selects one of the neighboring Bluetooth devices, and sends a request for connection to the selected Bluetooth device in response to a manual operation. If verification is required by the selected Bluetooth device for wireless communication, the verification procedure needs to be manually completed. Moreover, the electronic device and the Bluetooth device can communicate with each other only when the verification is finished. It is inconvenient and troublesome.

Therefore, what is needed is an electronic device and a method for creating a wireless communication connection for the electronic device which can alleviate or even overcome the limitations described above.

### BRIEF DESCRIPTION OF THE DRAWINGS

The emphasis is placed upon clearly illustrating the principles of the present disclosure.

FIG. 1 is a block diagram of an electronic device in accordance with an embodiment of the present invention.

FIG. 2 is a flowchart of a method for creating a wireless communication for an electronic device, such as the one of FIG. 1, in accordance with an embodiment of the present invention.

### DETAILED DESCRIPTION

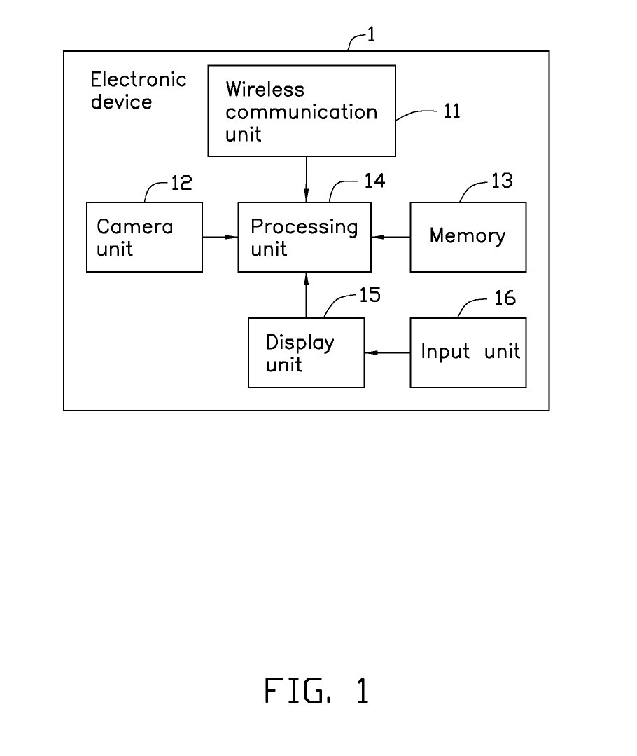

FIG. 1 is a block diagram of an electronic device 1 in accordance with an embodiment. The electronic device 1 is typically a mobile terminal with a Bluetooth communication function, such as a mobile phone or a tablet computer, for example.

The electronic device 1 includes a wireless communication unit 11, a camera unit 12, a memory 13, and a processing unit 14.

The camera unit 12 is configured for capturing a picture of a neighboring Bluetooth-enabled device (hereinafter, “Bluetooth device”) in response to a manual operation for Bluetooth connection performed on the electronic device 1. The neighboring Bluetooth device can be a Bluetooth-enabled earphone, a Bluetooth-enabled speaker, or a mobile terminal with a Bluetooth communication function, for example. In this embodiment, the camera unit 12 is a camera equipped in the electronic device 1. Typically, the camera unit 12 is used for capturing a picture of the back of a neighboring Bluetooth device. Alternatively, the camera unit 12 is used for capturing a picture of the front of a neighboring Bluetooth device.

The memory 13 records a number of pictures of Bluetooth devices. The Bluetooth devices can communicate with the electronic device 1 via Bluetooth technology (Bluetooth is a registered certification mark). In this embodiment, the memory 13 stores a number of pictures of the backs of Bluetooth devices captured by a camera. These pictures can be captured by the camera unit 12 itself, and/or obtained from a source such as the Internet.

The processing unit 14 is configured for processing a picture captured by the camera unit 12 when a Bluetooth connection is sought, thereby obtaining a processed picture. The processing unit 14 is also configured for comparing the processed picture with the pictures stored in the memory 13, and determining whether the processed picture matches one of the pictures stored in the memory 13. The processing unit 14 is further configured for generating a trigger signal when the processed picture matches one of the pictures stored in the memory 13.

The wireless communication unit 11 creates a wireless communication connection between the electronic device 1 and the neighboring Bluetooth device (not shown) in response to the generated trigger signal. Then, the electronic device 1 and the neighboring Bluetooth device can communicate via Bluetooth technology. In this embodiment, the wireless communication unit 11 is a Bluetooth unit.

The electronic device 1 further includes a display unit 15 and an input unit 16. The display unit 15 is configured for displaying a user interface including a Bluetooth icon. In the present embodiment, the display unit 15 includes a display screen (not shown), and the input unit 16 includes a touch screen (not shown). The touch screen overlies the display screen. The processing unit 14 is configured for generating a control signal in response to a touch operation applied on the Bluetooth icon. The control signal activates the camera unit 12 to capture a picture of the back of the neighboring Bluetooth device. That is, when a user applies the touch operation on the Bluetooth icon, the user aims the camera unit 12 at the back of the neighboring Bluetooth device. In another embodiment, the control signal is generated in response to an operation applied on a shortcut key associated with the input unit 16.

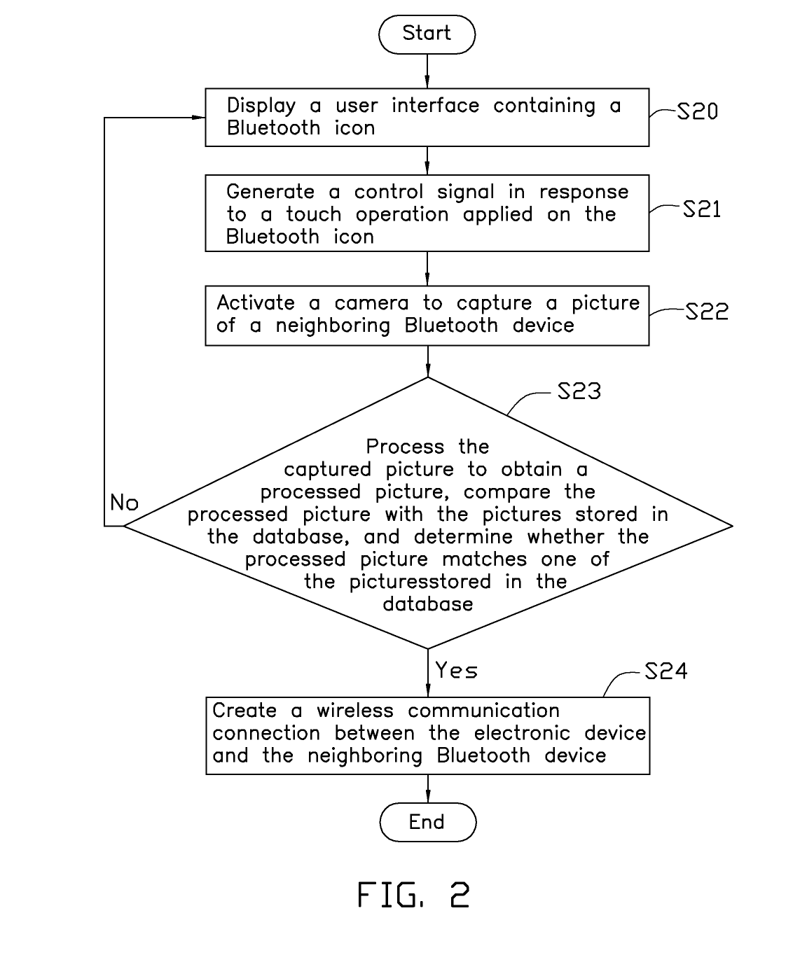

FIG. 2 is a flowchart of a method for creating a wireless communication connection for an electronic device, such as the electronic device 1, in accordance with an embodiment. The electronic device 1 includes a wireless communication unit 11, a camera unit 12, and a memory 13 storing a number of pictures of Bluetooth devices.

In step S20, the display unit 15 displays a user interface including a Bluetooth icon.

In step S21, the processing unit 14 generates a control signal in response to a touch operation applied on the Bluetooth icon.

In step S22, the control signal of the processing unit 14 activates the camera unit 12 to capture a picture of a neighboring Bluetooth device at which a user is aiming the electronic device 1.

In step S23, the processing unit 14 processes the picture captured by the camera unit 12 to obtain a processed picture, compares the processed picture with the pictures stored in the memory 13, and determines whether the processed picture matches one of the pictures stored in the memory 13. If the determination is yes, the procedure goes to step S23. Otherwise, the procedure goes back to step S20.

In step S24, the wireless communication unit 11 creates a wireless communication connection between the electronic device 1 and the neighboring Bluetooth device.

The above descriptions relate to Bluetooth technology wireless communication. However, the principles underlying the above descriptions are equally applicable to other kinds of wireless short-range radio communication and other kinds of wireless communication generally, such as Infrared Data Association technology. For example, in other embodiments, an electronic device may include an infrared communication unit.

In addition, although various embodiments have been specifically described, the disclosure is not to be construed as being limited thereto. Various changes or modifications may be made to the embodiments without departing from the scope and spirit of the disclosure.

What is claimed is:

1. A method for creating a wireless communication connection for an electronic device, the electronic device comprising a memory, the memory recording a plurality of pictures of wireless communication-enabled devices which can wirelessly communicate with the electronic device, the method comprising:
capturing a picture of a neighboring wireless communication-enabled device in response to a manual operation for wireless communication connection;
comparing the captured picture with the pictures stored in the memory, and determining whether the captured picture matches one of the pictures stored in the memory; and
creating a wireless communication connection between the electronic device and the neighboring device when the captured picture matches one of the pictures stored in the memory.

2. The method as described in claim 1, further comprising displaying a user interface including an icon representing wireless communication, wherein the manual operation is applied on the icon.

3. The method as described in claim 1, wherein the captured picture of the neighboring device is the back of the neighboring device.

4. The method as described in claim 1, wherein comparing the captured picture with the pictures stored in the memory comprises processing the captured picture to obtain a processed picture, and comparing the processed picture with the pictures stored in the memory; and determining whether the captured picture matches one of the pictures stored in the memory comprises determining whether the processed picture matches one of the pictures stored in the memory.

5. An electronic device, comprising:
a memory, having stored therein a plurality of pictures of wireless communication-enabled devices which can wirelessly communicate with the electronic device;
a camera unit, configured for capturing a picture of a wireless communication-enabled device neighboring the electronic device in response to a manual operation for wireless connection applied on the electronic device;
a processing unit, configured for comparing the captured picture with the pictures stored in the memory and determining whether the captured picture matches one of the pictures stored in the memory; and
a wireless communication unit, configured for creating a wireless communication connection between the electronic device and the neighboring device when the captured picture matches one of the pictures stored in the memory.

6. The electronic device as described in claim 5, further comprising:
a display unit, configured for display a user interface containing an icon representing wireless communication; and
an input unit;
wherein the processing unit is further configured for generating a control signal in response to the manual operation applied on the icon through the input unit, and activating the camera unit to capture a picture of a neighboring wireless communication-enabled device in response to the control signal.

7. The electronic device as described in claim 5, wherein the camera unit captures a picture of a back of a neighboring wireless communication-enabled device, and the plurality of pictures of wireless communication-enabled devices stored in the memory comprise a plurality of pictures of backs of wireless communication-enabled devices.

8. The electronic device as described in claim 5, wherein the processing unit is configured for processing the captured picture to obtain a processed picture, comparing the processed picture with the pictures stored in the memory, and determining whether the processed picture matches one of the pictures stored in the memory in order to determine whether the captured picture matches one of the pictures stored in the memory.
